(19) United States
(12) Patent Application Publication
(10) Pub. No.: US 2022/0405008 A1
(43) Pub. Date: Dec. 22, 2022

(54) MEMORY SYSTEM AND REFRESH CONTROL METHOD

(71) Applicant: Kioxia Corporation, Tokyo (JP)

(72) Inventor: Yoko MASUO, Iruma Saitama (JP)

(21) Appl. No.: 17/549,707

(22) Filed: Dec. 13, 2021

(30) Foreign Application Priority Data
Jun. 22, 2021 (JP) 2021-103451

(51) Int. Cl. G06F 3/06

(52) U.S. Cl. CPC G06F 3/0655; G06F 3/0604; G06F 3/0679

(57) ABSTRACT

According to one embodiment, a memory system includes a nonvolatile, memory and a controller. The nonvolatile memory includes a first block, a second block and a third block. In a first case where the first block is a block being allocated to the first area, and the second block is a block storing no valid data, the controller selects the second block as a block to which the data that has to be refreshed is to be moved. In a second case where the first block is a block being allocated to the second area, and the third block is a block in which valid data of a block different from the first block is possibly to be mixed, the controller selects the third block as a block to which the data that has to be refreshed is to be moved.

### CROSS-REFERENCE TO RELATED APPLICATIONS

This application is based upon and claims the benefit of priority from Japanese Patent Applications No. 2021-103451, filed Jun. 22, 2021, the entire contents of which are incorporated herein by reference.

### FIELD

Embodiments described herein relate generally to a memory system and a refresh control method.

### BACKGROUND

There is known a memory system such as a solid state drive (SSD) in which a NAND flash memory (NAND memory) is included. In such a memory system, a process referred to as garbage collection for reusing a storage area having unnecessary data, i.e., invalid data stored in the NAND memory is necessary. The garbage collection is also referred to as compaction. The garbage collection includes a process of moving or copying valid data stored in a certain storage area to another storage area in the NAND memory.

In this type of memory system, a process referred to as refresh, in which valid data stored in the NAND memory is stored again, is also necessary. Similarly to the garbage collection, the refresh includes a process of moving or copying valid data stored in a certain storage area to another storage area in the NAND memory.

Therefore, it is considered that data to be moved for refresh is mixed as a part of data to be moved for garbage collection, and moving or copying the data for refresh is performed in garbage collection. That is, the use of a part of the garbage collection process for the refresh process is considered.

Recently, a zoned Name Space (ZNS) standard has been proposed in the NVM Express™ (NVMe™) specification. On a storage area, a memory system in conformance with the ZNS standard sets a name space to which a management unit, which is referred to as a zone, is applied. Such a name space includes a plurality of zones. The size of the zone is determined according to the unit in which the memory system manages the storage area. To the zones, a host that is connected to the memory system sequentially writes data corresponding to the size of the zone at a time. When data stored in a certain zone is updated, the host collectively updates data corresponding to the size of the zone. When data stored in a certain zone is erased or invalidated, the host collectively erases or invalidates data corresponding to the size of the zone.

In a name space including a plurality of zones, arrangement of data may be controlled for each size of the zone. Therefore, it is expected that a write amplification factor (WAF) of the memory system is reduced as assumed.

On the other hand, in a memory system in which a name space including a plurality of zones is set, when a part of the garbage collection process is also used for the refresh process, it is necessary to perform control such that an event that data of different zones is mixed or data stored in a zone is divided does not occur.

### BRIEF DESCRIPTION OF THE DRAWINGS

FIG. 1 is a diagram illustrating an example of a configuration of a memory system according to an embodiment.

FIG. 2 is a diagram illustrating an example of a configuration of a NAND memory die included in a NAND memory of the memory system according to the embodiment.

FIG. 3 is a diagram illustrating an example of a configuration of a super block managed by the memory system according to the embodiment with respect to the NAND memory.

FIG. 4 is a conceptual diagram illustrating an example of a setting of a zone management name space in the memory system according to the embodiment.

FIG. 5 is a conceptual diagram illustrating an example of a transition of a state of a super block in the memory system according to the embodiment.

FIG. 6 is a diagram for explaining an outline of garbage collection performed in the memory system according to the embodiment.

FIG. 7 is a diagram for explaining an outline of garbage collection for the purpose of refresh, which is performed targeted for a super block associated with a zone management name space in the memory system according to the embodiment.

FIG. 8 is a diagram for explaining garbage collection for the purpose of refresh performed in the memory system according to the embodiment.

FIG. 9 is a conceptual diagram illustrating writing data to an extra area of a super block performed in the memory system according to the embodiment.

FIG. 10 is a flowchart illustrating a procedure of garbage collection for the purpose of refresh performed in the memory system according to the embodiment.

FIG. 11 is a diagram illustrating a first operation when a data write error occurs during garbage collection of the memory system according to the embodiment.

FIG. 12 is a diagram illustrating a second operation when a data write error occurs during garbage collection of the memory system according to the embodiment.

FIG. 13 is a flowchart illustrating a procedure of an operation when a data write error occurs during garbage collection of the memory system according to the embodiment.

### DETAILED DESCRIPTION

Embodiments will be described hereinafter with reference to the accompanying drawings.

In general, according to one embodiment, a memory system includes a nonvolatile memory and a controller. The nonvolatile memory includes a plurality of blocks including a first block, a second block and a third block. The controller controls the nonvolatile memory. The controller allocates a certain block of the blocks to a first area or a second area other than the first area. In a first case where the first block is a block storing data that has to be refreshed and being allocated to the first area, and the second block is a block storing no valid data, the controller selects the second block as a block to which the data that has to be refreshed is to be moved, and moves, to the second block, data of the first block including the data that has to be refreshed. In a second case where the first block is a block storing the data that has to be refreshed and being allocated to the second area, and the third block is a block in which valid data of a block different from the first block is possibly to be mixed, the controller selects the third block as a block to which the data that has to be refreshed is to be moved, and moves, to the third block, data of the first block including the data that has to be refreshed.

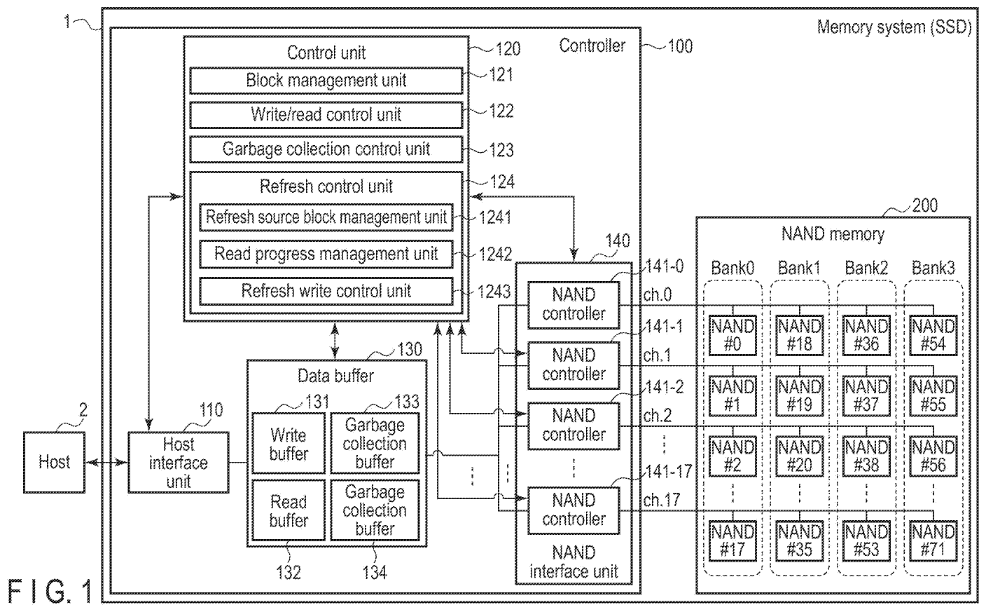

FIG. 1 is a diagram illustrating an example of a configuration of a memory system 1 according to the present embodiment. Here, an example will be described in which the memory system 1 is implemented as an SSD.

The memory system 1 comprises a controller 100 and a NAND flash memory (in the following, referred to as a NAND memory) 200. The memory system 1 is connectable to a host 2.

The controller 100 is a device that controls the NAND memory 200. The controller 100 is formed as, for example, a semiconductor integrated circuit such as a System on a Chip (SoC).

The NAND memory 200 is a nonvolatile storage medium that can overwrite no data in a storage area in which data has already been written. Data is updated to the NAND memory 200 by invalidating original data stored in a certain storage area and writing new data to another storage area. The NAND memory 200 includes a plurality of physical blocks. The physical block is a minimum unit of data erasure.

The controller 100 comprises a host interface unit 110, a control unit 120, a data buffer 130, and a NAND interface unit 140.

The host interface unit 110 is a device that controls communication with the host 2. The memory system 1 and the host 2 are connected with an interface in conformance with, for example, PCI Express™ (PCIe™) specification. The memory system 1 communicates with the host 2 using, for example, a protocol in conformance with the NVMe™. That is, the host interface unit 110 includes a circuit that performs communication in conformance with PCIe and NVMe.

The control unit 120 is a device that controls components in the controller 100, more specifically, the host interface unit 110, the data buffer 130, and the NAND interface unit 140. The control unit 120 receives a command from the host 2 through the host interface unit 110. The command received from the host 2 includes a write command requesting writing data, a read command requesting reading data, and the like. The control unit 120 executes writing data to the NAND memory 200 and reading data from the NAND memory 200 through the NAND interface unit 140 while using the data buffer 130 as a temporary data storage area. The control unit 120 transmits a result of the process corresponding to the command to the host 2 through the host interface unit 110.

The data buffer 130 is, for example, a static random access memory (SRAM). The data buffer 130 may be provided as a dynamic RAM (DRAM) or the like outside the controller 100.

The NAND interface unit 140 is a device that controls access to the NAND memory 200. More specifically, the NAND interface unit 140 writes data stored in the data buffer 130 to the NAND memory 200, or reads data from the NAND memory 200 and stores the data into the data buffer 130.

The control unit 120 comprises a processor such as a CPU. The control unit 120 implements various processing units such as a the block management unit 121, a write/read control unit 122, a garbage collection control unit 123, and a refresh control unit 124 by a processor executing firmware (program) stored in the NAND memory 200, for example. A part or all of these, various processing units may be implemented by hardware such as an electronic circuit instead of being implemented by a processor executing a program. Note that the refresh control unit 124 includes a refresh source block management unit 1241, a read, progress management unit 1242, and a refresh write control unit 1243.

The block management unit 121 is a module that manages a logical block (in the following, referred to as a super block), which is an extended management unit formed with a certain number of physical blocks in a plurality of physical blocks included in the NAND memory 200. The block management unit 121 manages information of a super block as block information. The block management unit 121 supplies the super block to the write/read control unit 122, the garbage collection control unit 123, and the refresh control unit 124.

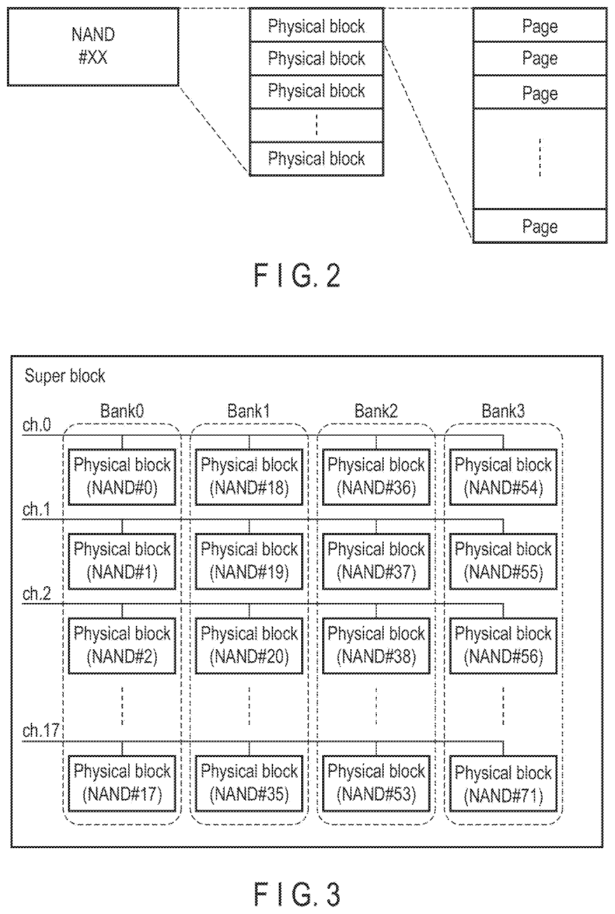

Here, the super block managed by the block management unit 121 will be described with reference to FIGS. 2 and 3 in addition to FIG. 1.

As illustrated in FIG. 1, the NAND memory 200 includes a plurality of NAND flash memory dies (in the following, referred to as a NAND memory die) #xx. In FIGS. 1 to 3, NAND memory die #xx is simply referred to as NAND #xx. NAND memory die #xx includes a memory cell array including a plurality of physical blocks and capable of storing data in a nonvolatile, manner, and a peripheral circuit that controls the, memory cell array. NAND memory dies #xx can operate independently. That is, a certain number of NAND memory dies #xx function as parallel operation units. NAND memory die #xx is also referred to as a NAND flash memory chip, a nonvolatile memory chip, or the like. NAND memory die #xx can be connected to a plurality of channels (e.g., 18 channels Ch.0 to Ch.17) by the same number (e.g., four NAND memory dies per channel). The channels Ch.0 to Ch.17 include a communication line (memory bus) for communicating with NAND memory dies #xx by a plurality of NAND controllers 141_0 to 141_17 of the NAND interface unit 140.

For example, NAND memory dies #0 to #17, NAND memory dies #18 to #35, NAND memory dies #36 to 453, and NAND memory dies #54 to #71, which are connected 18 to the respective channels Ch.0 to Ch.17 in Parallel, may be organized as Banks 0 to 3. The bank functions as a unit for operating a certain number of NAND memory dies #xx in parallel by bank interleaving. In the configuration example illustrated in FIG. 1, up to 72 NAND memory dies #xx can be operated in parallel by bank interleaving using four banks with 18 channels.

FIG. 2 is a diagram illustrating an example of a configuration of NAND memory die #xx.

As illustrated in FIG. 2, NAND memory die #xx includes a plurality of physical blocks each including a plurality of pages. Writing data to and reading data from NAND memory die #xx are processed in units of pages. On the other hand, data erasure is processed in units of super blocks formed with a plurality of physical blocks included in each of the plurality of NAND memory dies #xx. For NAND memory die #xx, data is not overwritten on a page to which data has been written. Therefore, the data is updated by invalidating the original data in a certain page and writing new data to another page. Therefore, a state in which most of a certain super block is occupied by unnecessary data (invalid data) may occur. A ratio of valid data to an effective area occupying an active area in which data can be stored except a defective page of a physical block included in a super block is referred to as an effective cluster rate or the like. Processing performed mainly for a super block having a small effective cluster rate and for reusing an area in which unnecessary data remains is referred to as garbage collection, compaction, or the like.

FIG. 3 is a diagram illustrating an example of a configuration of a super block managed by the block management unit 121.

The block management unit 121 manages a plurality of super blocks each including a plurality of physical blocks. In the memory system 1, at least data erasure is performed in units of the super blocks.

For example, the block management unit 121 selects one physical block from NAND memory dies #0 to #71 and manages a super block including a total of 72 physical blocks. Since NAND memory dies #0 to #71 can be operated in parallel by bank interleaving using 18 channels and four banks, for example, writing data to one super block can be performed by 72 pages each. Note that the block management unit 121 may manage the super block by selecting one physical block at a time from NAND memory dies #xx of which the number is smaller than 72 (e.g., 36 or 18). In regard to a combination of NAND memory dies #xx related to one super block, NAND memory dies #xx preferably have different channels and banks. When NAND memory dies #xx have a multi-plane (e.g., two planes) configuration, the block management unit 121 may select physical blocks one by one from 144 planes corresponding to NAND memory dies #0 to #71 and manage a super block including a total of 144 physical blocks, for example.

Returning to FIG. 1, the description of various processing units in the control unit 120 will be continued.

The write/read control unit 122 executes writing data to the NAND memory 200 or reading data from the NAND memory 200, which are requested from the host 2. More specifically, in the case of writing data, write data received through the host interface unit 110 is stored into the write buffer 131 of the data buffer 130. The write/read control unit 122 instructs any of the NAND controllers 141_0 to 141_17 of the NAND interface unit 140 to write the stored write data to the NAND memory 200. In the case of reading data, the write/read control unit 122 instructs any of the NAND controllers 141_0 to 141_17 of the NAND interface unit 140 to read data from the NAND memory 200. The read data is temporarily stored into the read buffer 132 of the data buffer 130 and transmitted to the host 2 through the host interface unit 110.

The write/read control unit 122 executes writing data to the NAND memory 200 upon receiving supply of a super block from the block management unit 121. The memory system 1 according to the present embodiment conforms to the ZNS standard of the NVMe specification. The memory system 1 according to the present embodiment can set a name space to which a management unit referred to as a zone is applied as a logical section on the storage area of the NAND memory 200 in cooperation with the host 2. In the following description, such a name space is referred to as a zone management name space. The zone management name space includes a plurality of zones of which a size is determined according to the size of the super block managed by the block management unit 121. For example, the size of the zone is determined such that a certain amount of extra area is secured in each super block when one super block is associated with one zone. The extra area is secured, and thus the size in which data can be stored into the zone can be kept constant, even though some defective pages occur in the super block, for example. For example, it is also possible to support extension of an error correcting code (FCC) for correcting an error of data using an extra area. The host 2 executes writing data to the zone management name space in units of zones and sequentially. That is, the host 2 requests writing data at a time from the head to the end of the zone. When writing data to the NAND memory 200 requested by the host 2 is a request for a zone in the zone management name space, the write/read control unit 122 receives the supply of the super block from the block management unit 121. The write/read control unit 122 stores data sequentially transmitted from the host 2 into the requested zone as a block of data. As described above, since writing is sequentially performed to the zone management name space in units of zones whose sizes are determined according to the size of the super block, garbage collection is unnecessary, and the WAF of the memory system 1 can be made relatively small.

The memory system 1 according to the present embodiment manages a logical section for a part of the storage area of the NAND memory 200 with a name space not including a zone. In the following description, such a name space is referred to as a non-zone management name space. The host 2 requests writing data to the non-zone management name space by a multiple of a minimum unit divided by a logical block address (LBA) allocated to a memory space (logical memory space) provided by the memory system 1 to the host 2. The minimum unit divided by the LBA is, for example, a page unit. The host 2 can randomly write to the non-zone management name space. When writing data to the NAND memory 200 requested by the host 2 is for the non-zone management name space, when an empty space remains in the latest super block most recently associated with the non-zone management name space, the write/read control unit 122 stores data from the host 2 into the empty space. When no empty space remains in the latest super block, or when the empty space is used up in the middle of writing data, the write/read control unit 122 receives a new super block from the block management unit 121, and stores the data transmitted from the host 2 into the supplied new super block in association with the non-zone, management name space.

In the non-zone management name space, update or erasure (or invalidation) of data is performed, for example, in units of pages, similarly to writing data. As described above, the data update is to invalidate the original data and write new data to another storage area.

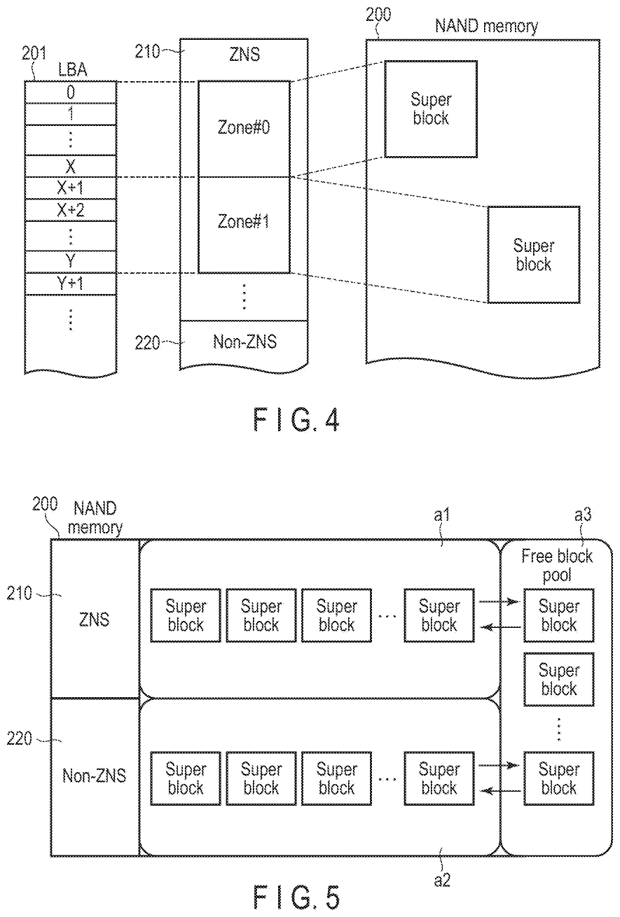

The block management unit 121 can determine, from the TBA specified by the host 2, whether or not writing data to the NAND memory 200 requested by the host 2 is for a zone in the zone management name space. FIG. 4 is a conceptual diagram illustrating an example of a setting of a zone management name space (ZNS) 210 in the memory system 1 according to the present embodiment.

The memory system 1 according to the present embodiment in conformance with the ZNS standard of the NVMe specification sets a zone management name space (ZNS) 210 on the storage area of the NAND memory 200 in cooperation with the host 2. To cooperate with the host 2 means, for example, to set the size of the zone in the zone management name space 210 corresponding to the size set from the host 2 to a size corresponding to the size of the super block managed by the block management unit 121. As described above, the size of the zone is determined such that a certain amount of extra area is secured in each super block when one super block is associated with one zone, for example. The host 2 sets the size of the zone management name space 210 by a multiple of the size of the zone determined with respect to the memory system 1.

The host 2 allocates the zone management name space 210 to any area in the logical address space. The, host 2 notifies the memory system 1 of the LBA 201 at the head of the area to which the zone management name space 210 in the logical address space is allocated and the size of the zone management name space 210. The size of the zone is determined according to the size of the super block in cooperation of the memory system 1 and the host 2. Therefore, in the memory system 1 that has received this notification, the LBA at the head of the zones in the zone management name space 210 can be obtained from the size of the zone. Thus, the memory system 1 can individually associate a super block with the zones in the zone management name space 210. The memory system 1 can determine whether or not writing data to the NAND memory 200 requested by the host 2 is for a zone in the zone management name space from the LBA specified by the host 2. Note that in FIG. 4, the non-zone management name space is represented as a non-ZNS 220.

Next, an example of a transition of the state of the super block in the memory system 1 according to the present embodiment will be described with reference to FIG. 5. FIG. 5 is a conceptual diagram illustrating an example of a transition of the state of the super block in the memory system 1 according to the present embodiment.

As described above, the memory system 1 according to the present embodiment in conformance with the ZNS standard of the NVMe specification sets the zone management name space 210 on the storage area of the NAND memory 200 in cooperation with the host 2.

The super block managed by the block management unit 121 can take three states, (a1) a state associated with the zone management name space 210, (a2) a state associated with the non-zone management name space 220, and (a3) a state not associated with any name space. Note that being associated with the zone management name space 210 is synonymous with being associated with any zone in a plurality of zones included in the zone management name space 210. Being not associated, with any name space means being in an unused state. In the following, the unused super block is also referred to as a free block. In FIG. 5, the free blocks are indicated as being stored in the free block pool for convenience. The unused super block includes a super block including no valid data and data has been erased to be usable or a super block usable by erasing data. The unused super block may include a super block that has never been used.

When all the stored data is invalidated, the super block in the state associated with the zone management name space 210 (in the following, referred to as a state (a1)) transitions to a state not associated with any name space (in the following, referred to as the state (a3)), i.e., a free block. The super block in the state associated with the non-zone management name space 220 (in the following, referred to as the state (a2)) also transitions to the state (a3) when all the stored data is invalidated.

The garbage collection control unit 123 and the refresh control unit 124 illustrated in FIG. 1 execute garbage collection that causes a super block in the state (a1) or a super block in the state (a2) to transition to the state (a3). That is, the memory system 1 according to the present embodiment has two systems of garbage collection mechanisms of the garbage collection control unit 123 and the refresh control unit 124. Although details will be described later, the garbage collection control unit 123 executes garbage collection for the purpose of securing a free block, and on the other hand, the refresh control unit 124 executes garbage collection for the purpose of refresh as a main purpose and for securing a free block as a secondary purpose. In the data buffer 130, the garbage collection buffer 133 is an area secured as a work area of the garbage collection control unit 123, and the garbage collection buffer 134 is an area secured as a work area of the refresh control unit 124.

On the other hand, the super block in the state (a3) transitions to the state (a1) or the state (a2) mainly when the super block is supplied from the block management unit 121 to the write/read control unit 122. This super block does not matter whether the super block has been associated with the zone management name space 210 or the non-zone management name space 220 before having been pooled in, the free block pool. That is, the super block may move between the zone management name space 210 and the non-zone management name space 220 through the free block pool. The erasure of the data of the super block in the state (a3) can be performed, for example, along with the transition of the super block to the state (a1) or the state (a2).

Note that also when the super block is supplied from the block management unit 121 to the garbage collection control unit 123 or to the refresh control unit 124, the super block in the state (a3) transitions to the state (a1) or the state (a2).

The plurality of physical blocks constituting the super block may be recombined between transition from the state (a1) or the state (a2) to the state (a3) and transition from the state (a3) to the state (a1) or the state (a2). For example, the block management unit 121 may manage the free block pool in units of physical blocks, and determine which of a plurality of physical blocks constitutes the super block when the super block is needed.

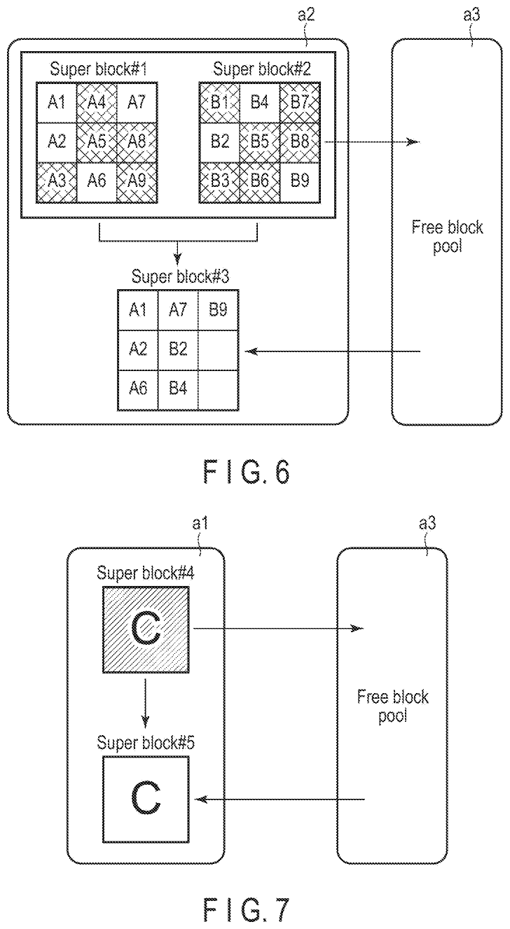

Next, an outline of the garbage collection performed by the garbage collection control unit 123 will be described with reference to FIG. 6. FIG. 6 illustrates an example in which two super blocks (#1 and #2) associated with the non-zone management name space 220 are garbage collection targets. That is, FIG. 6 illustrates an example in which two super blocks (#1 and #2) are in the state (a2). Here, for convenience of understanding, it is assumed that the super block includes nine pages.

In the non-zone management name space 220, update or erasure (or invalidation) of data is performed in units of pages, for example. Therefore, a situation in which more than half of pages in a certain super block are occupied by pages storing invalid data may occur with the lapse of time. A ratio of valid data to an effective area in which data can be stored and excluding a defective page or the like in the super block is referred to as an effective cluster rate or the like. The block management unit 121 manages an effective cluster rate for each super block, and provides a super block having a small effective cluster rate as a candidate for garbage collection to the garbage collection control unit 123.

Super block #1 includes pages A1 to A9. Super block #2 includes pages B1 to B9. Here, it is assumed that a hatched page (A3 to A5, A8, A9, B1, B3, and B5 to B8) is a page that stores invalid data. The garbage collection control unit 123 first receives supply of super block #3 from the block management unit 121. The garbage collection control unit 123 moves or copies valid data in super blocks #1 and #2, i.e., data stored in pages A1, A2, A6, A7, B2, B4, and b9 to super block #3. The garbage collection control unit 123 invalidates the valid data of super blocks #1 and #2 to make super blocks #1 and #2 free blocks. As a result, a page in which invalid data has been stored can be reused. That is, the free block is secured. Here, the valid data of two super blocks #1 and #2 is moved to one super block #3, and thus it is possible to secure one free block by subtraction. Moving the valid data of super blocks #1 and #2 to super block #3 in garbage collection may be copying the valid data of super blocks #1 and #2 to super block #3. In the following description, when the garbage collection is simply referred to as movement, the garbage collection may be copy instead of movement.

In addition to the purpose of securing a free block, the garbage collection can be performed for the purpose of refresh for maintenance of data that is not used (not rewritten) for a long period of time, which is referred to as cold data, for example. For example, when cold data is stored in some pages in a certain super block, and when this super block is set as a candidate for garbage collection, it is possible to implement cold data maintenance while reusing a page storing invalid data in the super block. The refresh control unit 124 executes garbage collection for the purpose of such refresh. The block management unit 121 manages the presence or absence of cold data that has to be refreshed for the super blocks. The block management unit 121 provides a super block in which cold data exists to the refresh control unit 124 as a candidate for garbage collection based on this management.

In addition to the cold data, the refresh can, be performed on, for example, data in which an error has occurred at the time of reading. The page storing the data in which the error has occurred may he a defective page. For example, setting a super block including such a defective page as a refresh target to correct data stored in the defective page by FCC, and the data is written to a non-defective page of the super block, which is a move destination. In regard to cold data, data used (rewritten) within a certain period, for example, is referred to as hot data or the like. In addition to this, the refresh can be performed with various events as factors, for example, targeting for data stored in a page near a page in which data frequently read is stored.

Although FIG. 6 illustrates an example in which the super block associated with the non-zone management name space 220 is selected, as a target for garbage collection, the super block associated with the zone management name space 210 may also be a target for garbage collection. In the zone management name space 210, data update or erasure (or invalidation) is performed in units of zones. For example, when data update is performed, the effective cluster rate of the super block in which the original data has been stored becomes zero. Therefore, the block becomes a free block without being provided from the block management unit 121 to the garbage collection control unit 123 as a candidate for garbage collection. In the case of the super block associated with the zone management name space 210, a page storing valid data and a page storing invalid data are not left in a mixed state.

However, the super block associated with the zone management name space 210 may also be a candidate for garbage collection for the purpose of refresh. The garbage collection for the refresh purpose is performed with the intention of using a part of the garbage collection process also for the refresh process, and is not performed in expectation that a free block is secured. Therefore, a super block having an effective cluster rate of 100% can also be a candidate. That is, a super block associated with the zone management name space 210 may also be a candidate. FIG. 7 is a conceptual diagram illustrating an outline of garbage collection for the purpose of refresh performed targeted for a super block associated with the zone management name space 210.

FIG. 7 illustrates an example in which data C in super block #4 associated with the zone management name space 210 is cold data that has not been used (not rewritten) for a long period of time. That is, FIG. illustrates an example in which the super block (#4) is in the state (a1).

First, the refresh control unit 124 receives supply of super block #5 from the block management unit 121. As described above, in the case of the super block associated with the zone management name space 210, a page storing valid data and a page storing invalid data are not mixed. The refresh control unit 124 moves data C in super block #4 to super block #5. Also in garbage collection for the refresh purpose, the copy may be used, not the movement. The refresh control unit 124 invalidates data C of super block #4 to make super block #4 a free block. By writing to a new super block, cold data maintenance is implemented. Also in garbage collection for the purpose of refresh, moving the valid data of super block #4 to super block #3 may be copying to super block #3.

Note that FIG. 7 illustrates an example in which the super block associated with the zone management name space 210 is a candidate for garbage collection for the purpose of refresh. However, needless to say that a super block associated with the non-zone management name space 220 may also be a candidate for garbage collection for the purpose of refresh.

That is, the candidate for garbage collection for the purpose of refresh may include a super block associated with the zone management name space 210 and a super block associated with the non-zone management name space 220. However, in refresh of the super block associated with the zone management name space 210, data has to be moved in units of super blocks. In other words, an event such as data stored in a plurality of super blocks being mixed in one super block or data stored in one super block being divided into a plurality of super blocks does not have to occur. That is, it is necessary to perform control such that an event such as data stored in a plurality of zones being mixed in one zone or data stored in one zone being divided into a plurality of zones does not occur.

In the memory system 1 according to the present embodiment, in order to appropriately execute refresh of the super block associated with the zone management name space 210, the refresh control unit 124 includes the refresh source block management unit 1241, a read progress management unit 1242, and a refresh write control unit 1243 illustrated in FIG. 1.

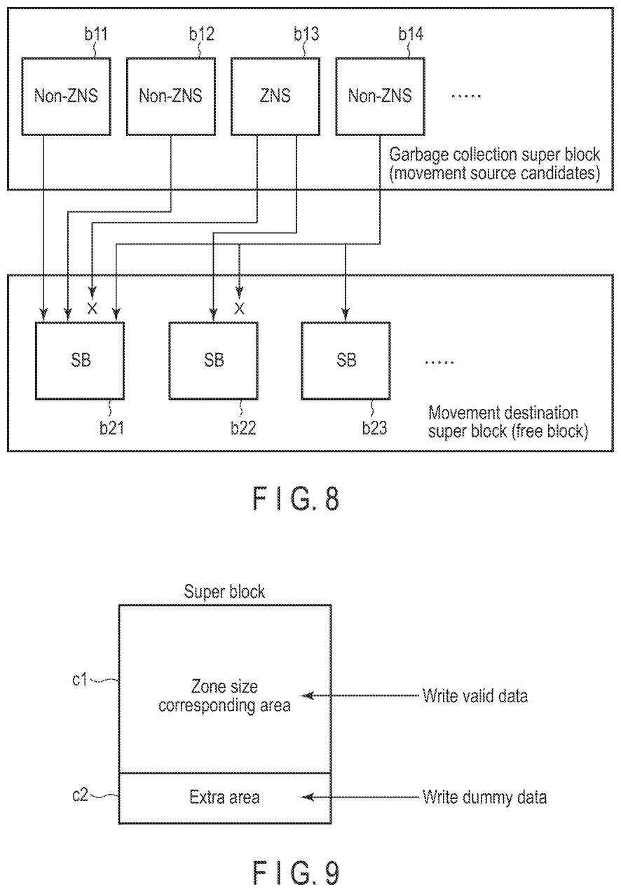

Here, garbage collection for the purpose of refresh performed in the memory system 1 according to the embodiment will be described with reference to FIG. 8.

In FIG. 8, a “non-ZNS” (b11, b12, and b14) represents a super block associated with the non-zone management name space 220. On the other hand, a “ZNS” (b13) represents a super block associated, with the zone management name space 210. The term “SB” (b21, b22, and b23) represents a super block taken out from the free block pool for garbage collection. The “non-ZNS” (b11, b12, and b14) and the “ZNS” (b13) are super blocks provided from the block management unit 121 to the refresh control unit 124 as garbage collection candidates (movement source candidates) for the purpose of refresh. Whether these are super blocks associated with the zone management name space 210 or super blocks associated with the non-zone management name space 220 is determined by the block management unit 121. When selecting one of the super blocks from the super blocks provided from the block management unit 121 as the movement source candidate, the refresh control unit 124 acquires, from the block management unit 121, a determination result as to whether the super block is the super block associated with the zone management name space 210 or the super block associated with the non-zone management name space 220. Note that the garbage collection by the refresh control unit 124 can be performed in parallel with the garbage collection by the garbage collection control unit 123. The block management unit 121 performs management so as not to redundantly provide the same super block as a candidate for garbage collection to the garbage collection control unit 123 and the refresh control unit 124.

In FIG. 8, the refresh control unit 124 first selects the non-ZNS b11 as a target for garbage collection. As a destination of valid data in the non-ZNS b11, the refresh control unit 124 receives supply of the SB b21 from the block management unit 121. The refresh control unit 124 moves valid data in the non-ZNS b11 to the SB b21, invalidates valid data in the non-ZNS b11, and makes the non-ZNS b11 a free block.

Here, it is assumed that an empty space remains in the SB b21 to which the valid data in the non-ZNS b11 has been moved. Subsequently, the refresh control unit 124 selects the non-ZNS b12 as a target for garbage collection. The refresh control unit 124 moves valid data in the non-ZNS b12 to the SB b21, invalidates valid data in the non-ZNS b12, and makes the non-ZNS b12 a free block. At this point, the data stored in the non-ZNS b11 and the data stored in the non-ZNS b12 are mixed in the SB b21.

Note that moving data in garbage collection can be performed, for example, in a many-to-one manner. The refresh control unit 124 can execute, for example, moving valid data in the non-ZNS b11 to the SB b21 and moving valid data in the non-ZNS b12 to the SB b21 in parallel. That is, the refresh control unit 124 may sequentially select super blocks to be subjected to garbage collection one by one, or may select a plurality of super blocks in parallel.

Here, it is assumed that an empty space still remains in the SB b21 to which the valid data in the non-ZNS b12 has been moved. Subsequently, the refresh control unit 124 selects the ZNS b13 as a target for garbage collection.

When a super block (here, the ZNS b13) associated with the zone management name space 210 is selected as a target for garbage collection for the purpose of refresh, the refresh control unit 124 sets a move destination of data stored in the super block as a new free block. Specifically, the refresh control unit 124 receives supply of the SB b22 from the block management unit 121, and moves valid data in the ZNS b13, i.e., all data, to the SB b22 instead of the SB b21.

When a super block associated with the zone management name space 210 is selected as a target for garbage collection for the purpose of refresh, the refresh source block management unit 1241 performs control not to select a super block to be a target for next garbage collection until moving data related to the super block is completed.

When a super block associated with the, zone management name space 210 is selected as a target for garbage collection for the purpose of refresh, the read progress management unit 1242 monitors the progress of reading data from the super block by the refresh control unit 124. When reading the data from the super block of the garbage collection target is completed, the read progress management unit 1242 notifies the refresh write control unit 1243 of the completion of reading the data.

The refresh write control unit 1243 controls writing data to the super block as the move destination of the data in garbage collection for the purpose of refresh. When the super block associated with the zone management name space 210 is selected as a target for garbage collection for the purpose of refresh, the refresh write control unit 1243 performs control so as to stop writing further data to the super block of the move destination of the data at a time point when the notification of completion of reading the data is received from the read progress management unit 1242. Specifically, writing data outside the zone is suppressed to the extra area secured in the super block associated with the zone.

Since the refresh source block management unit 1241 performs control such that the next super block is not selected as a target for garbage, collection, and the refresh write control unit 1243 performs control such that writing further data to the super block of the data move destination is stopped, valid data in other super blocks is not mixed into the SB b22. Therefore, since all the data in the ZNS b13 can be moved to the SB b22, the data in the ZNS b13 is not separately moved into a plurality of super blocks. As a result, the memory system 1 according to the present embodiment can appropriately refresh the, data stored in the zone using the garbage collection mechanism without causing an event that data outside the zone is mixed or data stored in the zone is divided.

That is, the memory system 1 according to the present embodiment has a mode of moving valid data in N (N is a natural number of two or more) super blocks to M (M is a natural number of one or more, and M<N) super blocks and a mode of moving valid data in one super block to another super block on a one-to-one basis, and adaptively switches between the two modes.

The refresh control unit 124 moves all the data in the. ZNS b13 to the SB b22, invalidates the data in the ZNS b13, and makes the ZNS b13 a free block. The refresh control unit 124 selects the next super block to be subjected to garbage collection for the purpose of refresh. Here, the non-ZNS b14 is selected.

The refresh control unit 124 moves valid data in the non-ZNS b14 to the SB b21 in which an empty space remains. It is assumed that the SB b21 becomes full while the data of the non-ZNS b14 is being moved. The SB b22 supplied from the block management unit 121 after the SB b21 is occupied by data moved from the ZNS b13. Therefore, the refresh control unit 124 receives supply of the SB b23 from the block management unit 121. The refresh control unit 124 continues moving the remaining data of the non-ZNS b14 with the SB b23 as the move destination.

As described above, in garbage collection (including refresh) of the super block associated with the non-zone management name space 220, the memory system 1 according to the present embodiment moves valid data in the N super blocks to the M (M<N) super blocks as a conventional manner. FIG. 8 illustrates an example in which valid data in, three super blocks is moved to two super blocks.

As described above, the size of the zone is determined such that a certain amount of extra area is secured in each super block when one super block is associated with one zone, for example. When receiving the notification from the read progress management unit 1242, the refresh write control unit 1243 may write dummy data having a certain pattern, for example, in the extra area of the super block instead of stopping writing further data to the super block as the data move destination. The dummy data is invalid data that includes no valid data. The dummy data may be a predetermined data pattern. FIG. 9 is a diagram illustrating an example of writing data to the super block as the move destination of the data performed in garbage collection for the purpose of refresh.

As illustrated in FIG. 9, the super block as the data move destination has a zone size corresponding area c1 and an extra area c2. The zone size corresponding area c1 is an area used as a zone in the area in the super block. The extra area c2 is, for example, an area that is secured to make it possible to keep the size of the area used as the zone size corresponding area c1 constant when a defective page occurs in the super block. The refresh write control unit 1243 writes the data in the super block, which is the movement source of the data, to the zone size corresponding area c1. The refresh write control unit 1243 writes dummy data having a certain pattern, for example, to the extra area c2.

By filling the extra area c2 with the dummy data, the reliability performance of the NAND memory 200 may be improved as compared with the case in which the extra area c2 is in an undefined state. The refresh write control unit 1243 may have a mode of writing dummy data in the extra area c2 and a mode of not writing dummy data. The refresh control unit 124 may switch these modes, for example, in response to a command from host 2.

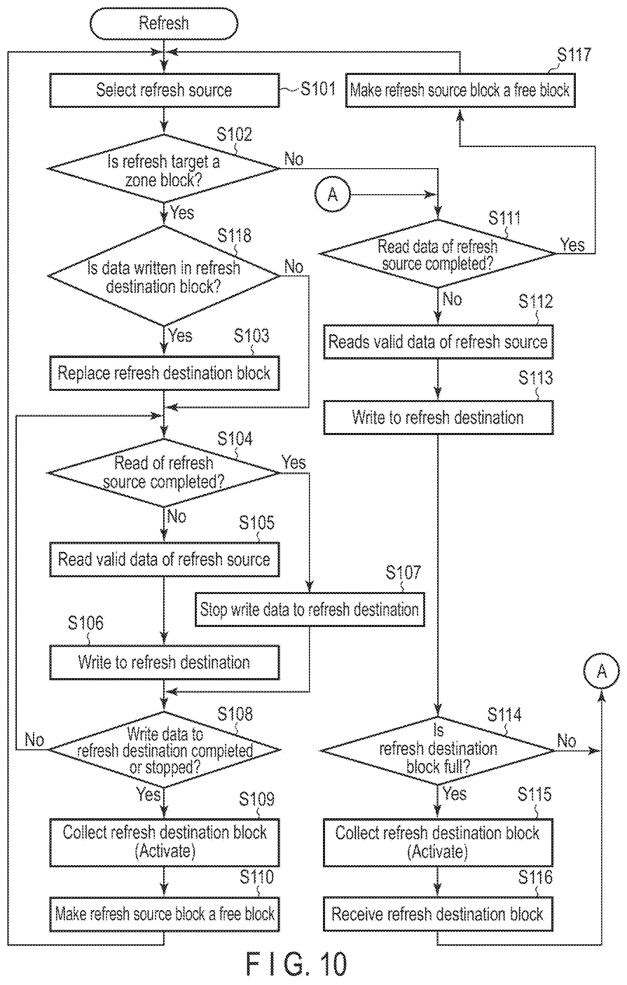

FIG. 10 is a flowchart illustrating a procedure of garbage collection for the purpose of refresh performed in the memory system 1 according to the present embodiment.

The refresh control unit 124 selects any super block from the super blocks provided from the block management unit 121 as a candidate for garbage collection for the purpose of refresh (S101). In the following, the super block from which the data is moved in garbage collection for the purpose of refresh is also referred to as a refresh source or a refresh source block, and the super block to which the data is moved is also referred to as a refresh destination or a refresh destination block. The super block associated with the zone management name space 210 is also referred to as a zone block.

The refresh control unit 124 determines whether a refresh target, i.e., a refresh source is a zone block (S102). Specifically, the refresh control unit 124 acquires a determination result as to whether or not the refresh source is a zone block from the block management unit 121. When the refresh source is the zone block (Yes in S102), the refresh control unit 124 determines whether or not data is written in the refresh destination block (S118). When data is written (Yes in S118), the refresh control unit 124 replaces the refresh destination block (S103). The replacement of the refresh destination block is to separately receive the supply of the super block as the refresh destination from the block management unit 121 even though an empty space remains in the super block as the refresh destination at that time. The refresh control unit 124 performs refresh on the data of the zone block selected as the refresh source with the newly supplied super block as the refresh destination. When no data is written to the refresh destination block (No in S118), the refresh control unit 124 skips S103, and performs refresh on the data in the zone block selected as the refresh source using the super block that is the refresh destination at that time.

More specifically, the refresh control unit 124 determines whether or not reading the data of the refresh source is completed (S104). When reading is not completed (No in S104), the refresh control unit 124 reads valid data (here, all data) of the refresh source (S105), and writes the valid data to the refresh destination (S106). On the other hand, when reading the data of the refresh source is completed (Yes in S104), the refresh control unit 124 stops writing data to the refresh destination (S107). Stopping writing data to the refresh destination is to suppress writing data of a refresh source block to be selected next. Note that in S107, instead of stopping writing data to the refresh destination, dummy data may be written to an extra area of the refresh destination.

The refresh control unit 124 determines whether or not writing data to the refresh destination is completed or whether or not writing data is stopped (S108). The completion of data writing means that the extra area of the refresh destination is filled with dummy data. When the writing the data is not completed or stopped (No in S108), the procedure of the garbage collection returns to S104.

When writing data to the refresh destination is completed or stopped (Yes in S108), the refresh control unit 124 collects the refresh destination block (S109). Collecting the refresh destination block is to change the state from a state during writing to an active state. The active state is a state in which data is not to be written and data can be read. The refresh control unit 124 makes the refresh source block a free block (S110). After that, the procedure of garbage collection returns to S101. That is, a process for the next refresh target is started.

When the refresh source is not the zone block (No in S102), the refresh control unit 124 performs refresh similar to the conventional one. More specifically, the refresh control unit 124 determines whether or not reading the data of the refresh source is completed (S111). When reading is not completed (No in S111), the refresh control unit 124 reads valid data of the refresh source (S112), and writes the valid data to the refresh destination (S113).

The refresh control unit 124 determines whether or not the refresh destination block is full (S114) When the state is not full and an empty space remains (No in S114), the procedure of garbage collection returns to S111. On the other hand, when the refresh destination block is full (Yes in S114), the refresh control unit 124 collects the refresh destination block (S115). The refresh control unit 124 receives a new refresh destination block (S116). Receiving the refresh destination block is to receive the supply of the super block as the refresh destination from the block management unit 121. After that, the procedure of garbage collection returns to S111.

When reading the data of the refresh source is completed (Yes in S111), the refresh control unit 124 sets the refresh source block as a free block (S117). After that, the procedure of garbage collection returns to S101. That is, a process for the next refresh target is started.

As described above, the memory system 1 according to the present embodiment can appropriately refresh the data stored in the zone using the garbage collection mechanism.

When data is written to the NAND memory 200, an error due to a failure on the NAND memory 200 side such as the occurrence of a defective page may occur. That is, an error due to a failure on the NAND memory 200 side such as the occurrence of a defective page may also occur at the time of writing data to the super block as a move destination for moving the data of the super block associated with the zone management name space 210 in garbage collection for the purpose of refresh.

As described above, the host 2 executes writing data to the zone management name space 210 in units of zones and sequentially. Therefore, in the super block associated with the zone, the write data of the host 2 is ideally arranged in the order intended by the host 2. Next, the operation of the refresh control unit 124 will be described based on this point when a data write error occurs during moving data in the super block associated with the zone will be described.

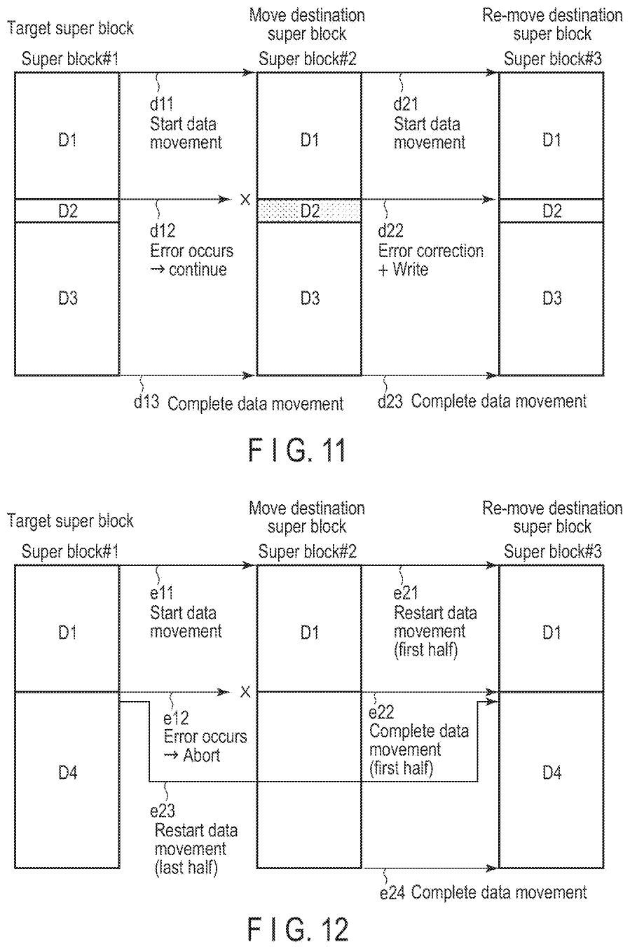

FIG. 11 is a diagram illustrating a first operation of the refresh control unit 124 when a data write error occurs during moving data in a super block associated with a zone.

FIG. 11 illustrates an example in which super block #1 is selected as a target for garbage collection for the purpose of refresh (target super block). Super block #1 that is a refresh source is a super block associated with a zone. FIG. 11 illustrates an example in which super block #2 is supplied as the super block of the refresh destination to which the data in super block #1 is moved. (move destination super block).

When the refresh source is a super block associated with a zone, the refresh control unit 124 sequentially reads data in the super block and sequentially writes the data in the super block to the super block of the refresh destination. Here, the case is assumed in which after the refresh control unit 124 starts moving data from, the refresh source to the refresh destination (d11), an error occurs at the time of writing data to the super block of the refresh destination or in which an error occurs at the time of reading the written data of the refresh source during moving data (d12). In FIG. 11, D1 represents data of which movement is completed before an error occurs. D2 represents data to be written in which an error has occurred.

Even when an error occurs during moving data to the super block of the refresh destination, the refresh control unit 124 continues moving data from the refresh source to the refresh destination (first operation). Here, in the following, it is assumed that the refresh control unit 124 completes moving data from the refresh source to the refresh destination without any error (d13). In FIG. 11, D3 represents data moved after the occurrence of an error.

The refresh control unit 124 completes moving the data in super block #1 to super block #2 while an error occurs. Subsequently, the refresh control unit 124 receives supply of a new super block for further moving the data in super block #2 from the block management unit 121 (re-move destination super block). Here, an example in which super block #3 is supplied is illustrated.

Similarly to moving data from super block #1 to super block #2, the refresh control unit 124 sequentially reads data in super block #2 and sequentially writes the data in super block #3. Here, the case is assumed in which after the refresh control unit 124 starts re-move destination data from super block #2 to super block #3 (d21), during moving data, an error occurs at the time of reading data from super block #2 due to the above-described error that occurs during moving data to super block #2 (d22). For example, the case is assumed in which an error is detected in data D2 by verification using ECC.

The refresh control unit. 124 corrects an error included in data D2 read from super block #2 using, for example, FCC, and writes the corrected data in super block #3 (d22). Note that error correction is, not limited to the method using ECC, and various known methods are applicable. The data read error is not limited to those caused by writing data, and may occur due to various causes such as a block after writing or a change in the state of data. However, applying various known methods including a method using FCC, and thus the refresh control unit 124 can cope with these errors.

After that, it is assumed that the refresh control unit 124 completes moving data from super block #2 to super block #3 (d23). As a result, garbage collection for the purpose of refresh, in which the refresh source is super block #1 and the refresh destination is super block #3, is completed.

Note that moving data from super block #1 to super block #2 is duplication of data, and it may be considered at a glance that data, remaining in super block #1 is moved to super block #3. However, the data of super block #1 becomes invalid data when the data of super block #2 is reassociated (i.e., updated) with respect to the logical address with which the data is associated. Therefore, the data written in super block #2 is moved to super block #3.

Next, referring to FIG. 12, a second operation of the refresh control unit 124 will be described when a data write error occurs during moving data in the super block associated with the zone.

FIG. 12 also illustrates an example in which super block #1 is the refresh source and super block #2 is the refresh destination. Here, the case is also assumed in which after the refresh control unit 124 starts moving data from the refresh source to the refresh destination (e11), an error occurs during writing data to the super block of the refresh destination or an error occurs during reading the written data of the refresh source destination (e12). In FIG. 12, D1 represents data of which movement is completed before an error occurs. D4 represents data targeted for moving subsequent to D1.

When an error occurs during moving the data to the super block of the refresh destination, the refresh control unit 124 interrupts moving the data to the refresh destination. The refresh control unit 124 receives supply of a super block to be a new refresh destination from the block management unit 121 (super block #3).

In this case, the refresh source block management unit 1241 manages an area in which data D1 on super block #2 is stored and an area in which data D4 on super block #1 is stored in association with each other. The refresh control unit 124 writes data D1 on super block #2 and data D4 on super block #1 in, super block #3 that is a new refresh destination according to the order managed by the refresh source block management unit 1241 (e21 to e24). As a result, garbage collection for the purpose of refresh, in, which the refresh source is super block #1 and the refresh destination is super block #3, is completed.

When an error occurs during moving data to super block #3, the refresh control unit 124 may further receive the supply of the super block to be a new refresh destination from the block management unit 121, and may move the data according to the order managed by the refresh source block management unit 1241.

Even in the second operation, it may be considered at a glance that data D1 remaining in super block #1 is moved to super block #3. However, since the data becomes invalid data when an update regarding a logical address is completed, data D1 written to super block #2 is moved to super block #3.

For example, the refresh control unit 124 may adaptively select one of the first operation described with reference to FIG. 11 and the second operation described with reference to FIG. 12 according to the progress of reading data from the refresh source, which is managed by the read progress management unit 1242. For example, the refresh control unit 124 may select the first operation when the remaining amount of data that has not been read from the refresh source is equal to or less than a threshold, and may select the second operation when the remaining amount exceeds the threshold. For example, in the former case in which data read has progressed to some extent, the refresh control unit 124 selects the first operation that can quickly make the super block, which is a refresh source, a free block. On the other hand, in the latter case in which the remaining amount of data is large, the refresh control unit 124 selects the second operation that can reduce unnecessary write and reduce the wear of the NAND memory 200.

For example, the refresh control unit 124 may adaptively select one of the first operation and the second operation according to the remaining number of free blocks, i.e., according to the writable remaining capacity of the NAND memory 200. The remaining number of free blocks is managed by the block management unit 121. When the remaining number of free blocks is equal to or less than the threshold, the refresh control unit 124 selects the first operation that can quickly make the super block, which is a refresh source, a free block. On the other hand, when the remaining number of free blocks exceeds a threshold value, the refresh control unit 124 selects the second operation that can reduce unnecessary writing and reduce the wear of the NAND memory 200.

The refresh control unit 124 may adaptively select one of the first operation and the second operation according to both the progress of reading data from the refresh source and the writable remaining capacity of the NAND memory 200. The refresh control unit 124 may fixedly apply one of a mode that applies the first operation and a mode that applies the second operation based on a command from host 2, for example.

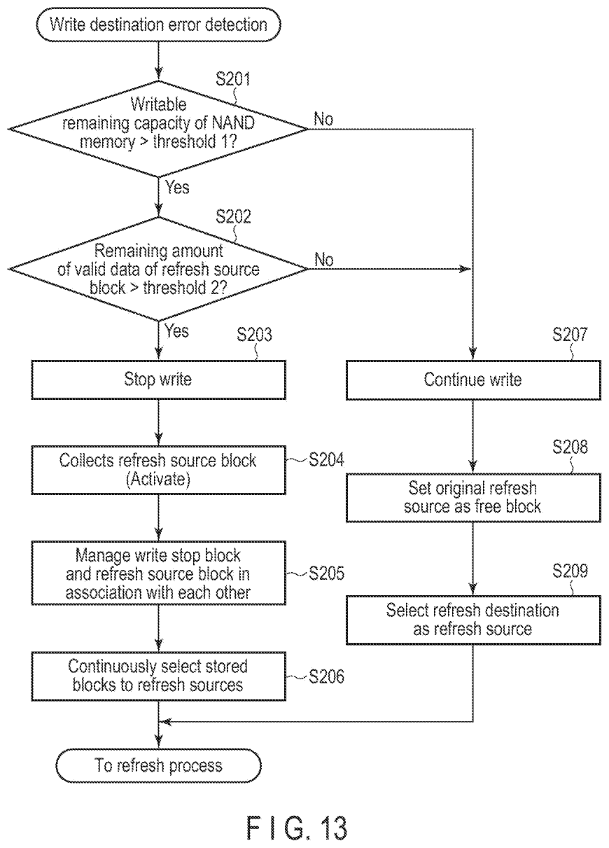

FIG. 13 is a flowchart illustrating an operation procedure when a data write error occurs during moving data in a super block associated with a zone of the memory system 1 according to the present embodiment.

The refresh control unit 124 checks whether or not the writable remaining capacity of the NAND memory 200 exceeds a threshold (threshold 1) (S201). When the remaining amount of valid data exceeds the threshold (Yes in S201), the refresh control unit 124 next checks whether or not the remaining amount of valid data of the refresh source block exceeds a threshold (threshold 2) (S202). When the amount exceeds the threshold (Yes in S202), the refresh control unit 124 selects the second operation described with reference to FIG. 12, and executes the process in S203 to S206.

Specifically, the refresh control unit 124 first stops writing data to the refresh destination (S203). The refresh control unit 124 collects the refresh source block, and temporarily returns the state of the refresh source block from the state of being written as the refresh source to the active state (S204). The refresh control unit 124 manages a refresh destination block (write stop block) at that time point in which data to be moved exists in a distributed manner and a refresh source block in association with each other (S205). The refresh control unit 124 continuously selects these managed blocks as refresh sources (S206). The refresh control unit 124 executes the refresh process of moving data from the refresh source to the refresh destination again.

On the other hand, when the writable, remaining capacity of the NAND memory 200 is equal to or smaller than threshold 1 (No in S201) or when the remaining amount of valid data of the refresh source block is equal to or smaller than threshold 2 (No in S202), the refresh control unit 124 selects the first operation described with reference to FIG. 11 and executes the processes of S207 to S209.

Specifically, the refresh control unit 124 first continues writing data to the refresh destination (S207). When writing data is completed, the refresh control unit 124 sets the refresh source block as a free block (S208), and selects a refresh destination where writing data is completed as a new refresh source (S209). The refresh control unit 124 again executes the refresh process for moving data from a new refresh source to a refresh destination.

As described above, the memory system 1 according to the present embodiment can appropriately refresh data stored in a zone using the garbage collection mechanism without causing an event that data outside the zone is mixed or data stored in the zone is divided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
A nonvolatile memory including a plurality of blocks including a first block, a second block and a third block; and
a controller configured to control the non-volatile memory,
wherein the controller is configured to
allocate a certain block of the blocks to a first area or a second area other than the first area,
in a first case where the first block is a block storing data that has to be refreshed and being allocated to the first area, and the second block is a block storing no valid data, select the second block as a block to which the data that has to be refreshed is to be moved, and move, to the second block, data of the first block including the data that has to be refreshed, and
in a second case where the first block is a block storing the data that has to be refreshed and being allocated to the second area, and the third block is a block in which valid data of a block different from the first block is possibly to be mixed, select the third block as a block to which the data that has to be refreshed is to be moved, and move, to the third block, data of the first block including the data that has to be refreshed.

2. The memory system of claim 1, wherein the first area is a name space including a plurality of zones defined by a Zoned Name Space standard of a NVM Express specification.

3. The memory system of claim 2, wherein the controller is configured to stop writing data to the second block at a time when moving the data of the first block to the second block is completed, in the first case.

4. The memory system of claim 2, wherein the controller is configured to write dummy data to an extra area in the second block after moving the data of the first block to the second block is completed, in the first case.

5. The memory system of claim 1, wherein the controller is configured to stop writing data to the second block at a time when moving the data of the first block to the second block is completed, in the first case.

6. The memory system of claim 1, wherein the controller is configured to write dummy data to an extra area in the second block after moving the data of the first block to the second block is completed, in the first case.

7. The memory system of claim 1, wherein when an error occurs in writing data of the first block to the second block in the first case, the controller is configured to continue moving the data from the first block to the second block, select a new fourth block in which no valid data is stored after completion of moving the data from the first block to the second block, and move data from the second block to the selected fourth block.

8. The memory system of claim 9, wherein the controller is configured to restore data in which the error occurs in the writing to the second block by an error correction code, and write the restored data to the fourth block.

9. The memory system of claim 1, wherein when an error occurs in writing data of the first block to the second block in the first case, the controller is configured to interrupt moving the data from the first block to the second block, select a new fourth block in which no valid data is stored, move, from the second block to the fourth block, data that has been moved from the first block to the second block, and move data remaining in the first block from the first block to the fourth block.

10. The memory system of claim 1, wherein
the controller includes a first mode and a second mode,
the first mode is a mode in which, when an error occurs in writing the data of the first block to the second block in the first case, the controller is configured to continue moving the data from the first block to the second block, select a new fourth block in which no valid data is stored after completion of moving the data from. the first block to the second block, and move data from the second block to the selected fourth block,
the second mode is a mode in which, when the error occurs, the controller is configured to interrupt moving the data from the first block to the second block, select the fourth block, move, from the second block to the fourth block, data that has been moved from the first block to the second block, and move data remaining in the first block from the first block to the fourth block, and
the controller is configured to select one of the first mode or the second mode based on at least one of an amount of data remaining in the first block or a remaining capacity of the nonvolatile memory.

11. A refresh control method for a memory system comprising a nonvolatile memory including a plurality of blocks including a first block, a second block, and a third block, the refresh control method comprising:
allocating a certain block of the blocks to a first area or a second area other than the first area;
in a first case where the first block is a block storing data that has to be refreshed and being allocated to the first area, and the second block is a block storing no valid data, selecting the second block as a block to which the data that has to be refreshed is to be moved, and moving data of the first block including the data that has to be refreshed to the second block; and
in a second case where the first block is a block storing the data that has to be refreshed and being allocated to the second area, and the third block is a block in which valid data of a block different from the first block is possibly to be mixed, selecting the third block as a block to which the data that has to be refreshed is to be moved, and moving data of the first block including the data that has to be refreshed to the third block.

12. The refresh control method of claim 11, wherein the first area is a name space including a plurality of zones defined by a Zoned Name Space standard of a NVM Express specification.

13. The refresh control method of claim 12, further comprising
stopping of writing data to the second block at a time when moving the data of the first block to the second block is completed, in the first case.

14. The refresh control method of claim 12, further comprising
writing dummy data to an extra area in the second block after moving the data of the first block to the second block is completed, in the first case.

15. The refresh control method of claim 11, further comprising
stopping of writing data to the second block at a time when moving the data of the first block to the second block is completed, in the first case.

16. The refresh control method of claim 11, further comprising
writing dummy data to an extra area in the second block after moving the data of the first block to the second block is completed, in the first case.

17. The refresh control method of claim 11, further comprising
when an error occurs in writing data of the first block to the second block in the first case, continuing moving the data from the first block to the second block, selecting a new fourth block in which no valid data is stored after completion of moving the data from the first block to the second block, and moving data from the second block to the selected fourth block.

18. The refresh control method of claim 17, further comprising
restoring data in which the error occurs in the writing to the second block by an error correction code, and writing the restored data to the fourth block.

19. The refresh control method of claim 11, further comprising
when an error occurs in writing data of the first block to the second block in the first case, interrupting of moving the data from the first block to the second block, selecting a new fourth block in which no valid data is stored, moving, from the second block to the fourth block, data that has been moved from the first block to the second block, and moving data remaining in the first block from the first block to the fourth block.

20. The refresh control method of claim 11, further comprising selecting one of a first mode or a second mode based on at least one of an amount of data remaining in the first block or a remaining capacity of the nonvolatile memory, wherein
the first mode is a mode including, when an error occurs in writing the data of the first block to the second block in the first case, continuing of moving the data from the first block to the second block, selecting a new fourth block in which no valid data is stored after completion of moving the data from the first block to the second block, and moving data from the second block to the selected fourth block, and
the second mode is a mode including, when the error occurs, interrupting of moving the data from the first block to the second block, selecting the fourth block, moving, from the second block to the fourth block, data that has been moved from the first block to the second block, and moving data remaining in the first block from the first block to the fourth block.
